(19) United States
(12) Patent Application Publication
(10) Pub. No.: US 2009/0114257 A1
(43) Pub. Date: May 7, 2009

(54) Handle and a Walking Aid Incorporating the Same

(75) Inventor: Stephen George Sutton, Hertfordshire (GB)

Correspondence Address: Kimberly A. Chasteen, PO Box 1243, Yorktown, VA, 23692, US

(73) Assignee: ORTHOCRUTCH LIMITED, EDGWARE, MIDDLESEX (GB)

(21) Appl. No.: 11/792,791

(22) PCT Filed: Sep. 12, 2005
(86) PCT No.: PCT/GB05/03508

§ 371 Date: Jul. 16, 2007

(30) Foreign Application Priority Data
Sep. 11, 2004 (GB) 0420215.6
Dec. 21, 2004 (GB) 0427904.8
Jan. 24, 2005 (GB) 0501370.1

(51) Int. Cl. A61H 3/02

(52) U.S. Cl. 135/72

(57) ABSTRACT

A walking aid comprises a leg with a handle located part way up the leg; the leg having a region below the handle which in use may engage the ground as a user leans onto the walking aid; and a region above said handle for supporting the arm of the user, the walking aid having the handle is an inclined elongate handle located between the leg's upper and lower regions the leg's handle, upper and lower regions have a common supporting bar; an arm being located across and beneath the handle between said upper and lower regions; and the arm formed of two parts which are clamped together to be secured onto the leg at the handle region; and/or the upper region is bowed; and/or said region for supporting the arm incorporates a cuff with a lateral opening and means allowing the cuff to be selectively attached to the leg with the opening in a first radial direction for use with the right arm and with the opening in a second radial direction for use with the left arm; and/or said walking aid incorporates a region above said handle for supporting the arm of the user which has a brace spaced from said handle sufficiently to be located over the lower forearm region above the wrist; and/or in addition to the inherent shock absorption of the handle, a damping compound is provided and located at least in part within the handle to cushion the pressure exerted by a user's hand on the handle; and/or a shock absorber is provided in close proximity to said handle as an integral part of the walking aid.

### FIELD OF THE INVENTION

The present invention relates to a handle suitable for use in any device where grip, support or lift is required. The invention is particularly useful for use in walking aids, such as crutches, walking sticks, walking frames, and the like.

### BACKGROUND TO THE INVENTION

A schematic diagram of a known crutch is shown in FIG. 1. This crutch is of a below-elbow type. The crutch comprises a lower leg 1002, an upper arm support portion 1004, a hand grip 1006 disposed between the lower and upper portions, and a cuff 1008 disposed at an upper end of the arm support portion. The leg 1002 and the arm support portion 1004 are made of heavy wall, high strength aluminium tubing. The hand grip 1006 and the cuff are made of plastic. The hand grip is a solid handle or is moulded over a single above- or below-elbow tubular rod which is first bent at a desired angle. The leg is adjustable to vary the floor to hand grip length according to the needs of the user. The arm support portion is inclined at an angle relative to the leg so that in use the leg is vertical and the arm support portion is inclined at an angle to the vertical lower portion. The hand grip is disposed at right angles to the leg. Accordingly, the hand grip and the arm support portion form an angle greater than 90°.

A problem with this known arrangement is that, in use, when a user grips the hand grip with the cuff supporting the lower arm of the user, the arm of the user is at an angle to the vertical lower portion. Accordingly, forces imparted on the arm of the user comprise both horizontal and vertical components. This results in joint stress leading to anatomical damage. In particular, the prolonged use of known crutches can lead to patients developing carpel tunnel syndrome. In addition, the designs of known crutches make poor and inefficient use of the muscles of the user, leading to nerve damage and pain in both the arms and the chest of the user. Further, the components of the crutch are substantially rigid, resulting in impact shock being transmitted to the user which also may cause anatomical damage.

FIGS. 2 and 3 show schematic diagrams of known walking sticks. In the arrangement shown in FIG. 2, the handle 1010 is at right angles to the shaft 1012 of the stick. In the arrangement shown in FIG. 3, the hand grip 1014 is a ball grip located at the top of the shaft 1016. In both arrangements, the walking comprises substantially rigid components, resulting in impact shock being transmitted to the user during use. There is no support for the wrist of a user. Further, the geometric structure of the handle is not optimised to minimise stress imparted to a user during use.

All the walking aids hereinbefore described suffer from the disadvantage of causing anatomical damage to the user due to stresses being imparted to the user. It would be an advantage if an improved hand grip could be provided which results in reduced stress for the user and minimises anatomical damage.

Attempts at reducing the impact shock transmitted to the user of a walking aid are disclosed in U.S. Pat. No. 2,414,758, U.S. Pat. No. 2,300,726 and GB 2,318,510, in which sprung or resilient assemblies are incorporated into the feet of walking aids, such as crutches and walking sticks. While offering some improvement in reducing the stresses imparted to a user, compared with conventional, rigid designs, there remains a significant amount of anatomical damage resulting from prolonged use of the walking aids disclosed.

An improved walking aid is disclosed in CA 2,288,400 and in GB 2,355,662, in which a number of the aforementioned issues have been addressed. In particular, a walking aid is disclosed having an inclined handle and a cuff for supporting the upper arm of the user. A similar crutch is shown in UK Registered Design No. 2074016.

The development of an improved crutch is described in ‘The design of a compliant composite crutch’, D. Shortell, et al., Journal of Rehabilitation Research and Development, Vol. 38 No. 1, January/February 2001. The crutch comprises an S-curve in its main body to provide shock absorption, with the goal of reducing impact and repetitive injuries. In addition, the crutch is provided with a cuff for supporting the forearm and wrist of the user.

While the developments detailed above have improved the form and function of walking aids, there are still a number of problems that remain to be addressed, in order to provide better care for users requiring prolonged support from walking aids, such as crutches and the like. First, known designs of crutch tend to restrict the natural movement of the lower arm and elbow region of the user. This is particularly the case with designs that rely on the use of an extensive cuff for the lower arm. Further, cuffs provided with known crutches are closed loops, which are prone to trapping and constraining the arms of the user. This can be dangerous in the event of a fall whilst using the crutch. Open cuffs are known. However, the opening is generally provided at the sacrifice of support and comfort for the user. In addition, many crutch designs do not provide support for the wrist of the user. As a result, the wrist becomes one of the main fatigue regions for the user. Finally, the more recent crutch designs, intended to overcome the problems inherent in the traditional crutches, are complex in shape and form and tend to be difficult and, hence, costly to manufacture.

### SUMMARY OF THE INVENTION

In a first aspect, the present invention provides a walking aid comprising a leg with a handle located part way up the leg; the leg having a region below the handle which in use may engage the ground as a user leans onto the walking aid; and a region above said handle for supporting the arm of the user; characterised by any one or more of the following features:
a) the handle is an inclined elongate handle located between the upper and lower regions of the leg; the handle and upper and lower regions of the leg having a common supporting bar; an arm being located across and beneath the handle between said upper and lower regions; and the arm formed of two parts which are clamped together to be secured onto the leg at the handle region; and/or
b) the upper region is bowed; and/or
c) said region for supporting the arm incorporates a cuff with a lateral opening and means allowing the cuff to be selectively attached to the leg with the opening in a first radial direction for use with the right arm and with the opening in a second radial direction for use with the left arm; and/or
d) said walking aid incorporates a region above said handle for supporting the arm of the user which has a brace spaced from said handle sufficiently to be located over the lower forearm. region above the wrist; and/or
e) in addition to the inherent shock absorption of the handle, a damping compound is provided and located at least in part within the handle to cushion the pressure exerted by a user's hand on the handle; and/or
f) a shock absorber is provided in close proximity to said handle as an integral part of the walking aid; and/or
g) an upper portion being bowed with one end of the bow located over a scapular region and the opposite end located over a chest and/or upper humeral position of a user, so as to provide support to the user at the armpit/shoulder level; and/or
h) said region above the handle supports the arm of the user by engaging the armpit region of the user and the handle is inclined.

The handle configuration set out in feature a) above is particularly advantageous because it allows the walking aid to rely on the supporting strength of a common supporting bar. Therefore, in use, the walking aid is less likely to break at joints which would have been the case in a prior art crutch with several supporting bars. This configuration also allows an improved construction of the handle region as compared to the prior art system. It also reduces the number of components necessary, thus rendering the crutch more straightforward to manufacture at a lower cost.

In one embodiment of the present invention, at least one of the two parts of the handle is of plastics material with webbing or fibrous reinforcements. This allows the walking aid to be of minimal weight but of sufficient strength to withstand the periodic pressure exerted during a user's walk.

The bowed upper region is particularly advantageous because it allows the elbow region and/or forearm region of a user to be less constrained by the upper portion of the crutch in a non-ergonomic manner. In particular, the upper region is bowed or curved so as to lie outside the path followed by the arm of the user during normal use of the crutch. For example, the upper region may be curved in the same plane as the remainder of the leg so as to bow rearwards from the arm of the user during normal use. Alternatively, the upper region may be curved out of the plane occupied by the remainder of the leg, in particular to bow outwards to one side of the user during normal use of the walking aid.

In a preferred embodiment, the upper region of said leg has first and second bowed portions which are telescopic, such that the length of the bowed or curved portion may be adjusted. This allows the ergonomic aspects of the walking aid to be adjustable for users of different sizes.

The bowed upper region may comprise a single bowed portion extending substantially its entire length. Alternatively, the upper region may comprise a plurality of discrete bowed portions, interconnected by substantially straight portions.

Feature c) is particularly advantageous because it allows walking aids with lateral openings for added safety to be both suitable for the right and left arm. There is therefore no need to supply a pair of different walking aids. The opening is most preferably disposed on the cuff, so as to be on the outside of the arm of the user during normal use. The cuff is preferably mounted to the leg in a manner that allows it to be rotated and reversed, in order to orient the opening of the cuff for use with either the right or left arm of the user. It is a particular advantage of this arrangement, with the opening disposed laterally in the cuff, that the arm of the user is provided with support in the forwards and backwards directions, during normal use, which is of significant importance in reducing the levels of stress imparted to the limbs and body of the user.

Feature d) offers extra support to the forearm region of a user which is one of the most prone to fatigue in users of walking aids.

Feature e) is also particularly advantageous because it reduces the stress exerted on the hand and/or wrist of the user.

In a further embodiment, the damping compound is located between the supporting bar and a relatively rigid handle cover. This configuration is particularly advantageous because it allows absorption of the pressure exerted on the handle in order to reduce stress in the user's hand. It also allows the damping compound to be inserted within the geometry of the walking aid. It therefore does not unduly increase the size of the walking aid in order to achieve its beneficial effect.

In one embodiment, the damping compound is resilient, is formed in part over the handle and is ergonomically shaped. This allows the benefits of the damping compound to extend over the entire grip of a user.

Feature f) is also particularly advantageous because it reduces stress exerted on the hand and/or wrist of the user in an improved manner. This is as a result of the shock absorbing means being in close proximity to the user's hand and/or wrist.

In a further aspect, the present invention provides a walking aid comprising an elongate leg and a handle at an upper end of the elongate leg, the handle including an elongate hand grip to be gripped by a user in use, wherein the elongate hand grip is inclined at an obtuse angle with the longitudinal direction of the elongate leg.

With such an included handle, the walking aid is preferably provided with a means for preventing the hand of the user from slipping from the handle, such means including a collar, a ball or other protrusion against which the hand of the user may rest or abut.

In another aspect, the present invention provides a walking aid comprising an elongate leg and a handle, at an upper end of the elongate leg, wherein the handle includes a palm grip for fitting into a palm of the user's hand to grip the handle in use, and a connecting element extending between a side of the palm grip and the elongate leg, there being a continuous curved gripping surface, remote from the said side of the palm grip, extending between an upper surface and a lower surface of the palm grip.

According to still a further aspect of the present invention, there is provided a handle for use in a walking aid, said handle comprising an elongate lower portion for attachment to an elongate leg, and an elongate hand grip to be gripped by a user in use, wherein the elongate hand grip is inclined at an obtuse angle with a longitudinal direction of the lower portion.

In a further aspect, the present invention provides a handle for use in a disability device, said handle including a palm grip for fitting into a palm of the user's hand to grip the handle in use, and an attachment element extending from a side of the palm grip for attachment to said device, there being a continuous curved gripping surface, remote from the said side of the palm grip, extending between an upper surface and a lower surface of the palm grip.

The handle of the present invention is particularly useful for walking aids, such as crutches and walking sticks for people with disabilities or injuries. However, the hand grip according to embodiments of the present invention could be applied to any device where grip, support or lift is required. For example, handles according to the present invention may be disposed on the sides of a bath for aiding a person to lower themselves into the bath and lift themselves out of the bath. Handles according to the present invention may be applied to a Zimmer frame or other similar walking aid. The grips may be provided on furnishings, such as beds and chairs, to aid a user, and in particular a user who is disabled or injured, to move about and support themselves.

One particularly advantageous walking aid according to the present invention comprises a central metal frame having a continuous metal element bent in an S-shape to form a lower portion, for engaging with the ground in use, a central handle portion, and an upper portion for supporting the arm of the user in use. A handle assembly is provided comprising two or more components attached around the central handle portion, to provide a handle for gripping by the user. The handle assembly advantageously comprises two half handle components which are clipped or clamped around the central handle portion of the metal element. In this way, the walking aid is simple and cheap to manufacture in large numbers, while retaining all the advantages of the present invention discussed hereinbefore.

### BRIEF DESCRIPTION OF THE FIGURES

Preferred embodiments of the present invention will now be described, by way of example only, having reference to the accompanying drawings, in which:

FIG. 1 is a schematic representation of a known crutch;

FIG. 2 is a schematic representation of a known walking stick;

FIG. 3 is a schematic representation of another known walking stick;

FIGS. 4a, 4b and 4c respectively show a right hand side elevation, a front elevation and a left hand side elevation of a crutch according to one embodiment of the present invention;

FIG. 5 shows an exploded view of the end region of the upper portion of a walking aid;

FIG. 6 shows a portion of a walking aid incorporating a damping compound;

FIGS. 7a, 7b and 7c respectively show a right hand side elevation, a front elevation and a left hand side elevation of a crutch in accordance with a further embodiment of the present invention;

FIGS. 8a, 8b and 8c respectively show a right hand side elevation, a front elevation and a left hand side elevation of a crutch in accordance with a further embodiment of the present invention;

FIG. 9 shows a shoulder-high walking aid in accordance with a further embodiment of the present invention;

FIG. 10 shows the walking aid of FIG. 9 with an alternative upper assembly;

FIG. 11 shows a top view of the walking aid of FIG. 9;

FIG. 12 shows a top view of the walking aid of FIG. 10;

FIG. 13a shows a schematic side elevation of a shoulder-high walking aid in accordance with a further embodiment of the present invention and FIG. 13b shows a top view of a shoulder-high ring fitment which may be used with the walking aid of FIG. 13a;

FIG. 14 shows front and side elevations of a below-elbow crutch in accordance with a further embodiment of the present invention;

FIG. 15 shows front and side elevations of an above-elbow crutch in accordance with a further embodiment of the present invention;

FIG. 16 shows front and side elevations of a below-elbow crutch with an adjustable leg in accordance with another embodiment of the present invention;

FIG. 17 shows front and side elevations of an above-elbow crutch with an adjustable leg in accordance with another embodiment of the present invention;

FIG. 18 shows front and side elevations of an above-elbow crutch with a lateral curve in an upper portion thereof in accordance with a further embodiment of the present invention;

FIG. 19 shows front and side elevations of a multiple part crutch supplied as a kit in accordance with a further embodiment of the present invention, in which the below-elbow crutch of FIG. 16 has been fitted with an above-elbow extension;

FIG. 20 shows front and side elevations of a below-elbow crutch having a handle with an additional support bar for added shock absorbance and spring in accordance with another embodiment of the present invention;

FIG. 21 shows front and side elevations of an above-elbow crutch having a handle like that illustrated in FIG. 20 in accordance with another embodiment of the present invention;

FIG. 22 shows front and side elevations of a below-elbow crutch having a handle like that illustrated in FIG. 20 and an adjustable leg in accordance with another embodiment of the present invention;

FIG. 23 shows front and side elevations of an above-elbow crutch having a handle like that illustrated in FIG. 20 and an adjustable leg in accordance with another embodiment of the present invention;

FIG. 24 shows front and side elevations of a multiple part crutch supplied as a kit having a handle like that illustrated in FIG. 20, an adjustable leg, and a below-elbow type upper element in accordance with another embodiment of the present invention;

FIG. 25 shows front and side elevations of the multiple part crutch of FIG. 24 but with the below-elbow type upper element replaced with an above-elbow type upper element;

FIG. 26 shows a side view of a pair of crutches according to an embodiment of the present invention, each crutch being similar to the embodiment shown in FIG. 25 but with adjustable hinge joints between the handle, upper and lower portions of the crutch;

FIG. 27 shows a view of the crutches of FIG. 26 in use;

FIG. 28 shows front and side elevations of a crutch having an alternative handle and arm support arrangement in accordance with another embodiment of the present invention;

FIG. 29 shows a front elevation and a top view of a portion of a crutch having a handle comprising a ball grip in accordance with another aspect of the present invention;

FIG. 30 shows a side view of the portion of the crutch shown in FIG. 29;

FIG. 31 shows a front elevation and a top view of a portion of a crutch having a handle comprising a ball grip similar to that of FIGS. 29 and 30 but with an alternative attachment arrangement to a lower leg;

FIG. 32 shows a side view of the portion of the crutch shown in FIG. 31;

FIG. 33 shows a front and side elevations of the crutch shown in FIGS. 31 and 32 with an above-elbow extension element fitted thereto;

FIG. 34 shows an alternative arrangement of the below-elbow type crutch of FIG. 6 with wrist offset wings thereon;

FIG. 35 shows a schematic cross-sectional diagram from above of an embodiment of the wrist offset wings of FIG. 34; and

FIG. 35 shows a schematic cross-sectional diagram from above of an alternative embodiment of the wrist offset wings of FIG. 34.

### DETAILED DESCRIPTION OF THE FIGURES

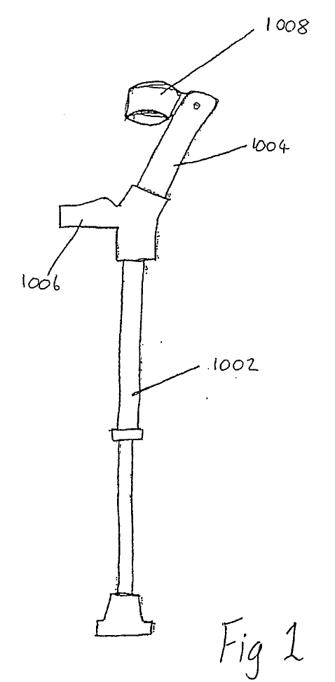

FIGS. 1 to 3 show prior art arrangements which are discussed hereinbefore in the introductory portion of this specification.

FIG. 3a shows a walking aid which in this embodiment is a crutch generally referenced 1 having an upper region 2, a lower region 3 and a handle region 4. The hand-engaging portion of the handle region 4 is referenced 5 and forms an angle of 115° relative to the vertical axis as shown in FIG. 3c. Other angles may be chosen for the handle 5 but these are preferably between 110 and 125°. As shown in FIG. 3c, the angle referred to is the angle formed between the handle and a vertical axis of the crutch in a downwards direction, such that in normal use, the handle 5 extends upwards in the rearwards direction. The handle 5 is essentially inclined but straight in the hand-engaging portion 5.

The handle region 4 is formed of two halves 6 and 7 which are secured together by attachment means 8 and 9 which may be nuts and bolts or any other appropriate attachment means as selected by the person skilled in the art. The halves 6 and 7 may each be a single piece moulding with internal reinforcements such as those shown in FIG. 3 in dashed line which form internal webbing reinforcements 10 and 11. The formation of the handle from two parts in this manner significantly improves the ease of manufacture of the crutch, in particular the formation of the handle region and its assembly.

A ball 12 may protrude from the portion of the walking aid between the handle 5 and the lower region 3 so as to form a stop for a user's hand in order to avoid inadvertent slippage from the handle 5 during use. A recessed trough 13 is provided at the junction between the handle 5 and the ball 12 which may be so sized and shaped to correspond to any particular user's size and shape.

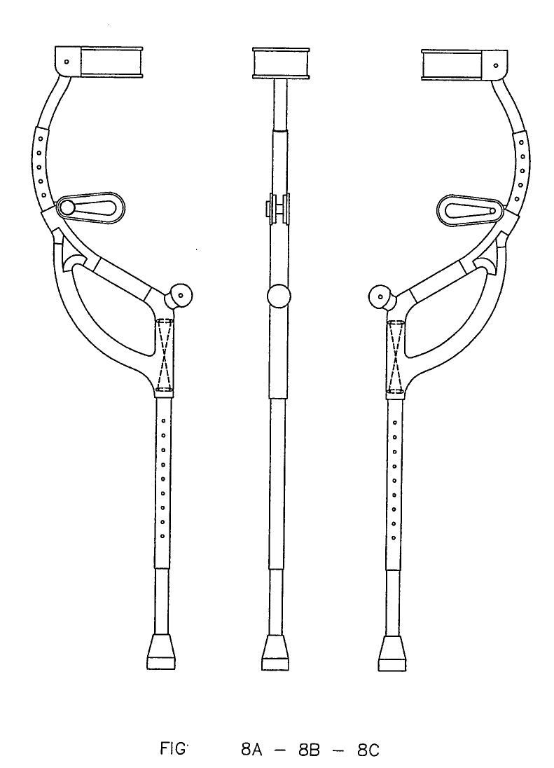

The halves 6 and 7 are clamped onto a common supporting bar shown in dashed lines in FIG. 6 and referenced 14. The supporting bar 14 has a protruding lower visible portion 15 and an upper visible portion 16. The lower portion 15 is in a straight line whereas the upper portion 16 is bowed with the apex of the bow being located radially outwards from the rest of the walking aid. The upper and lower portions 15 and 16 of the supporting bar 14 engage telescopically with a mating lower bar 17 and an upper bar 18 respectively. A number of holes are provided in the lower portion which allows a holding mechanism of known kind to be used to secure the lower bar 17 at a variety of different lengths. Similarly, the upper portion 16 of the common supporting bar 14 incorporates a number of holes which operate with a holding mechanism of known kind to allow the attachment of the upper bar 18 at a variety of lengths to suit a particular user of the walking aid.

Both the upper portion 16 and the upper bar 18 are bowed in order to allow a user's arm more unrestrained movement below a cuff 19.

The cuff 19 is pivotally mounted to the upper bar 18 via a pivot 20. The cuff 19 has a lateral opening 21 which allows a user's arm to exit the walking aid if necessary, for example in the event of a fall.

The walking aid may also have a sole 22 which may be made out of rubber or any other suitable non-slip material. The invention also envisages the incorporation of damping means in the sole of the walking aid.

An optional feature of the walking aid is the use of a brace 23 which has two essentially parallel wings 24 and 25 which may receive the forearm of a user in order to offer it additional support. Each wing may be pivoted independently or in association with the other wing with reference to a joint 26. The brace 23 may be released from the walking aid by undoing a nut and screw arrangement such as that shown as 27 in FIG. 3b. Whilst the brace in this embodiment has two essentially parallel wings, it is envisaged that there may be provided a single wing located on the inside of the walking aid to relieve the pressure exerted on the user. This wing may be an integral part of the walking aid's main support bar or a wing which may be releasably attached thereto.

As part of the handle region 4 there is provided an arm 28 stretching underneath the handle 5 between the upper and lower regions 2 and 3. The arm 28 is also bowed outwardly. The arm 28 is so configured as to compensate for the bending movement applied on the crutch during use. The arm 28 is an integral part of the halves 6 and 7 assembly.

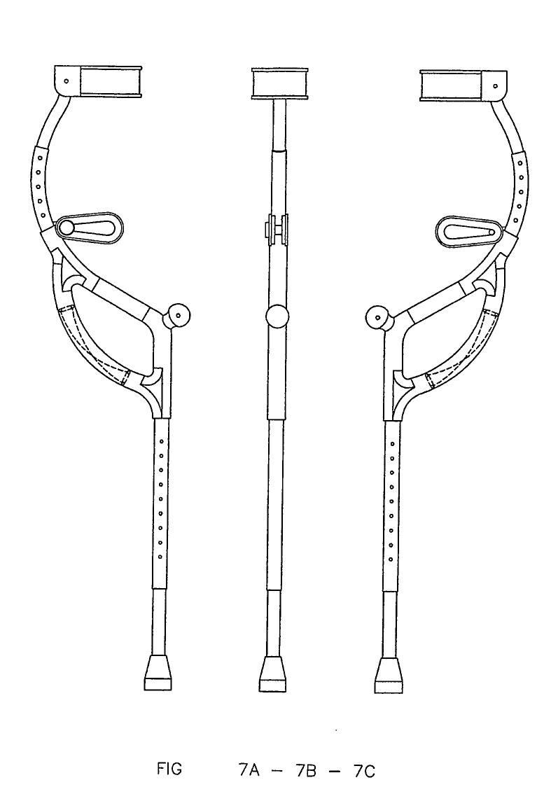

FIG. 5 shows an advantageous modification to the upper portion of the crutch. The upper portion 29 may be arranged to be releasable relative to a cuff 30 by removing a nut 31 and its bolt 32. This would allow the cuff 30 to be placed with the lateral opening on either the right hand side or the left hand side as appropriate. The cuff 30 is provided with a reinforcing rib 30a extending circumferentially along its centre line. In this way, the cuff can be stiff enough to provide support to the arm of the user, in particular in the forwards and backwards directions, during use, while remaining sufficiently flexible to allow the user to remove their arm from the cuff with ease.

FIG. 6 shows a handle region, generally referenced 33, where a damping compound such as a rubberised compound has been injected into a portion located between the common supporting bar 14 and the handle halves. The damping compound is shown as 34 in FIG. 6 where, in this particular embodiment, a portion 35 is located between the supporting bar 14 and the halves whilst a further portion 36 protrudes from the halves so that a user's hand may directly engage with the rubberised compound. The person skilled in the art may select a compound which may be injected through openings 37 and 38 located respectively above and below the handle so as to initially fill the gap between the halves and the supporting bar. With the provision of an opening within the halves, the compound may extrude from the halves and spread over the top of the handle so that it may be formed to the shape of a particular user's hand. This may be done by selecting an appropriate type of thermosetting compound and applying the user's hand whilst the compound has not fully set and removing the user's hand so that the compound sets ergonomically.

Whilst a rubberised compound has been envisaged in this embodiment, other damping arrangements may be utilised. A system of air chambers trapped within deformable plastics materials such as those found in the soles of shoes may also be suitable, in order to absorb the pressure.

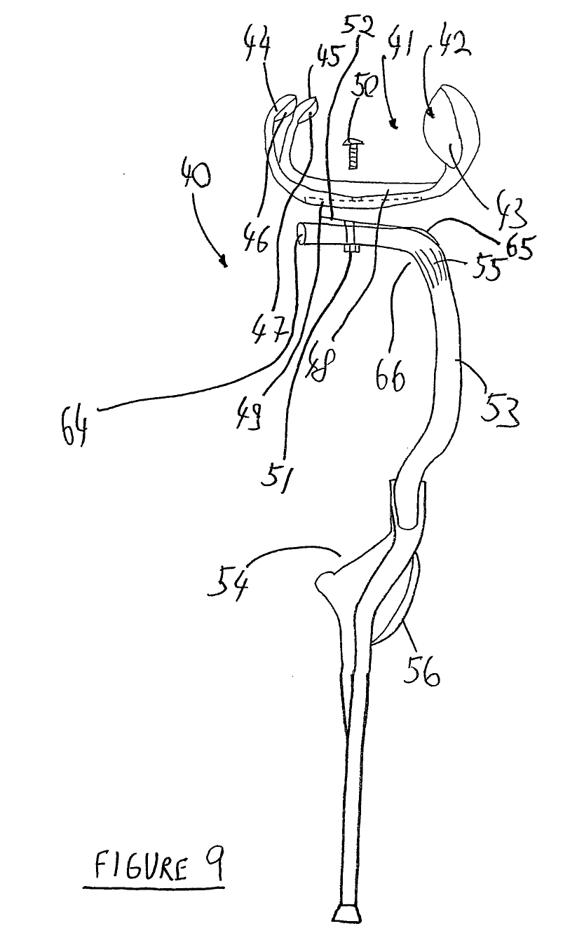

FIGS. 7a, 7b and 7c show schematically a shock absorber 33 located as part of the arm 28.

FIGS. 8a, 8b and 8c show an alternative shock absorber 34 located immediately beneath the inclined handle 5 and the ball 12.

FIG. 9 shows a walking aid, generally indicated as 40, with an upper shoulder high support portion 41 having a scapular support region 42 with padding 43 and two anterior support regions 44 and 45 forming a fork, each of which incorporates padding 46 and 47. The padding may be provided over an essentially central portion 48. A pneumatic padding assembly is one preferred embodiment.

On the underside of the upper support 41, there is provided a recess 49 which allows the sliding engagement of a bolt in order to fix the upper support 41 at a variety of angles in order to allow the walking aid to be fitted to a particular user and achieve improved support.

A bolt and nut arrangement 50 and 51 may be used to attach the upper support to the rest of the walking aid. A wedge shaped portion 52 may comprise a tunnel in which the bolt is housed during use.

A bowed elbow portion 53 and a handle portion 54 are provided which may have similar properties to those described with reference to the preceding figures. The elbow portion may comprise damping means such as a spring at the bend portion 55 of the elbow portion. Another damping means may be provided as part of the handle region as shown by an arm 56.

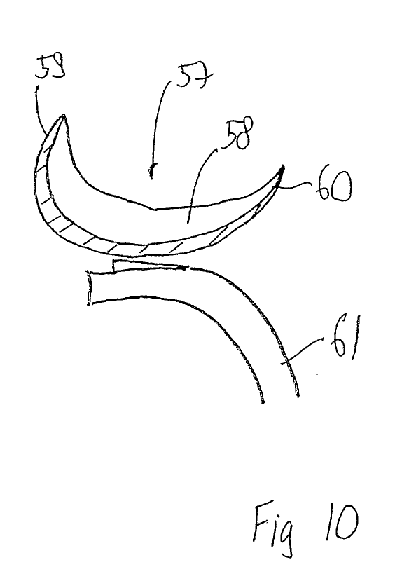

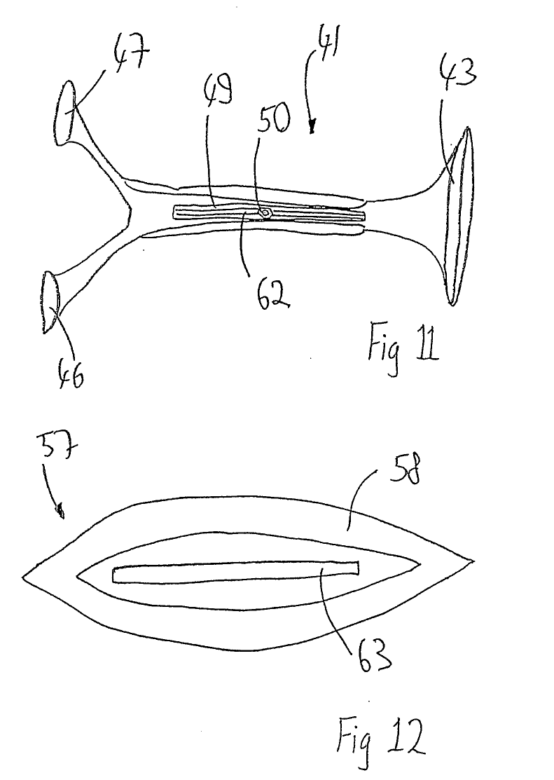

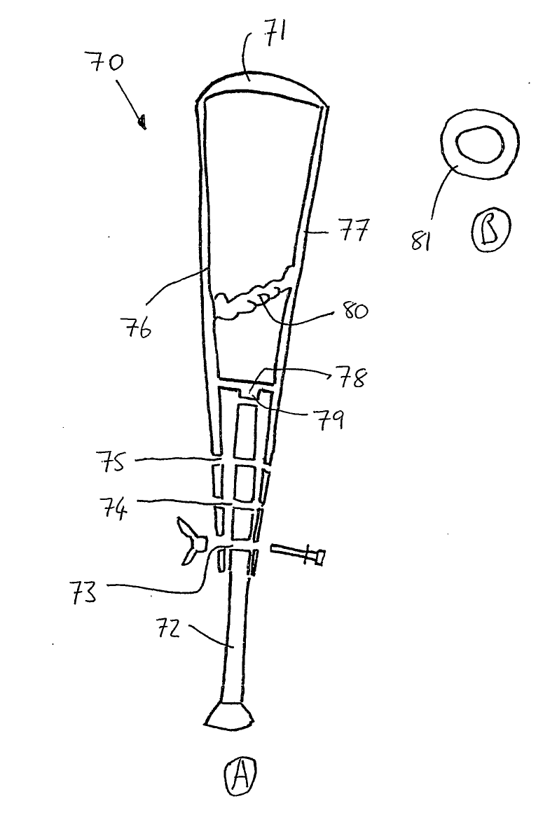

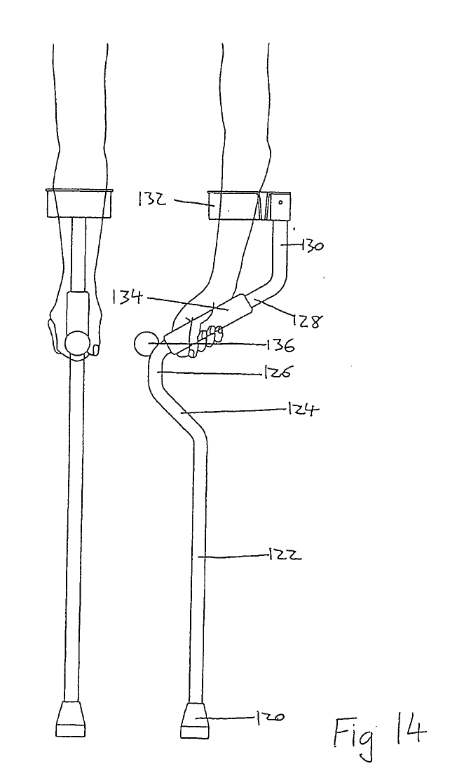

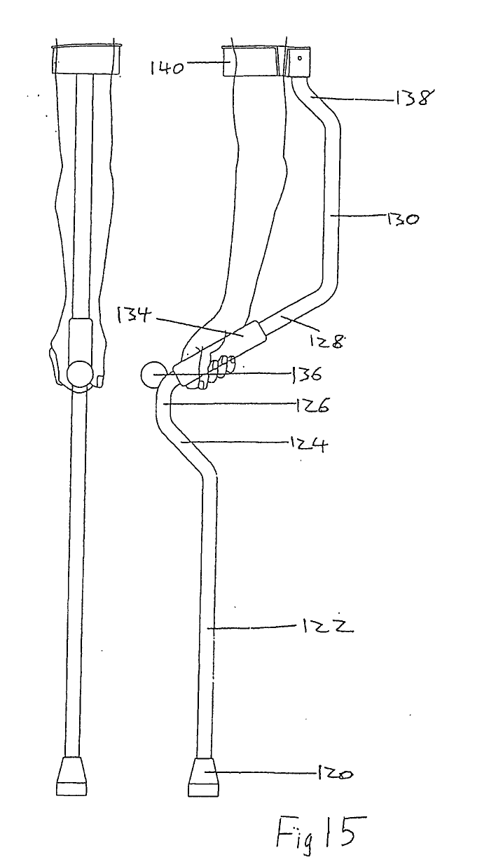

FIG. 10 shows a second embodiment of an upper support 57 in accordance with the present invention. This upper support is of a so-called ‘banana’ shape, with pneumatic padding 58 having a front region 59 and a rear region 60. Means may be provided as for the embodiment of FIG. 9 to allow the upper support portion 57 to be adjusted relative to the elbow portion 61.

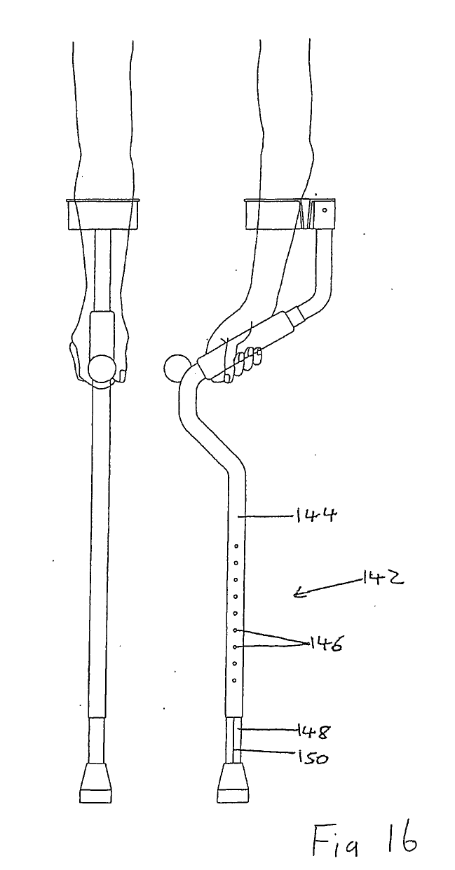

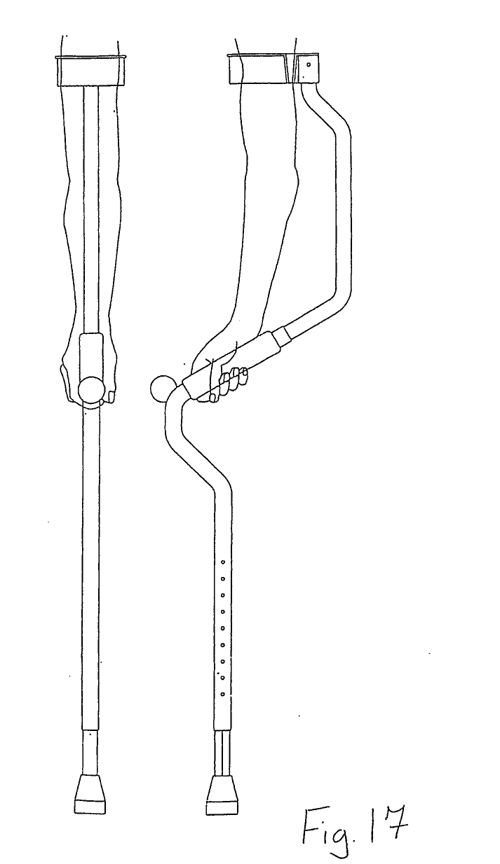

The embodiments of FIGS. 9 and 10 may be further clarified when referring to FIGS. 11 and 12. FIG. 11 shows the recess 49 in more detail, comprising a slot 62 in which a bolt 50 may be adjusted relative to the support portion 41 in order to be positioned to suit a particular user. FIG. 12 shows a top view of the upper portion 57 of the kind described with reference to FIG. 10 above. A pneumatic pad 58 is provided. A recess 63 similar to the kind described with reference to the preceding figures is also shown.

A compass 64 may be fitted at the extremity of the portion 53. A rubber stop 65 may be provided immediately above the upper bend 66 of the portion 53, as shown more clearly in FIG. 9.

FIG. 13 shows a walking aid generally referenced as 70 with a banana-shaped cushioned armpit portion 71. The walking aid is of a general Y-shape, with a lower leg region 72 which may be telescopically adjusted in terms of height due to bores 73, 74 and 75. A bolt and butterfly attachment may be used to secure the lower leg to the rest of the Y-shaped shoulder-high walking aid. Between the upper portion 76 and the upper portion 77 of the Y-shaped walking aid, there is provided a cross-piece 78 which may be adapted to absorb shock by incorporating a rubber portion 79. A handle 80 extends between the upper portions 76 and 77 and is inclined and forms an angle of approximately 115° relative to the vertical axis of the walking aid. Other angles may be chosen for this handle, preferably and angle between 110 and 125°, which would allow anatomical handgrip to occur. It is also envisaged to provide the extremities of the handle 80 with means to releasably attach the handle to the upper Y-shaped pieces in order to allow the attachment to be achieved at a variety of angles, which may be chosen for anatomical reasons to suit a particular user.

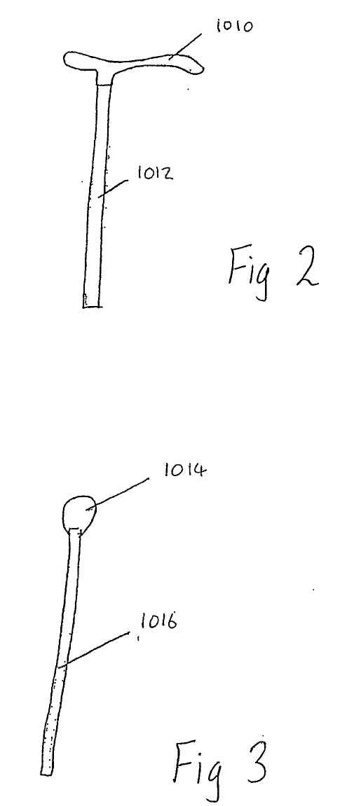

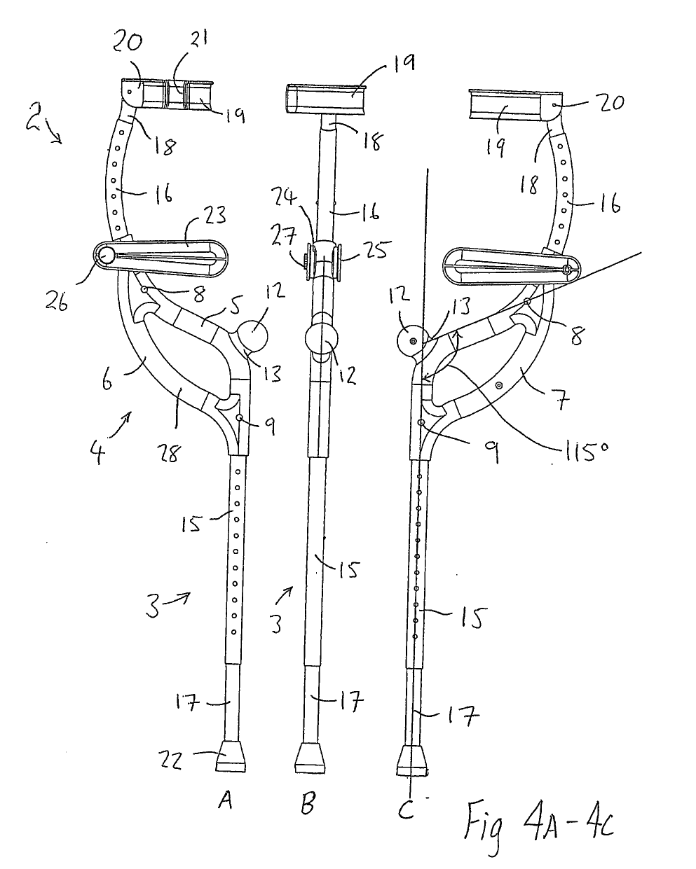

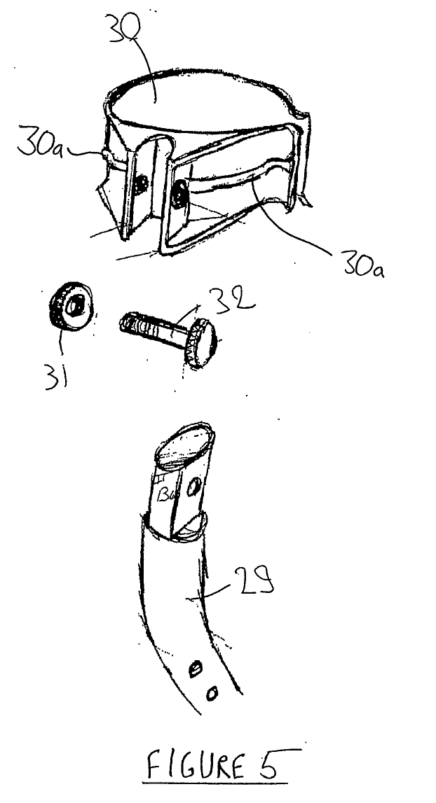

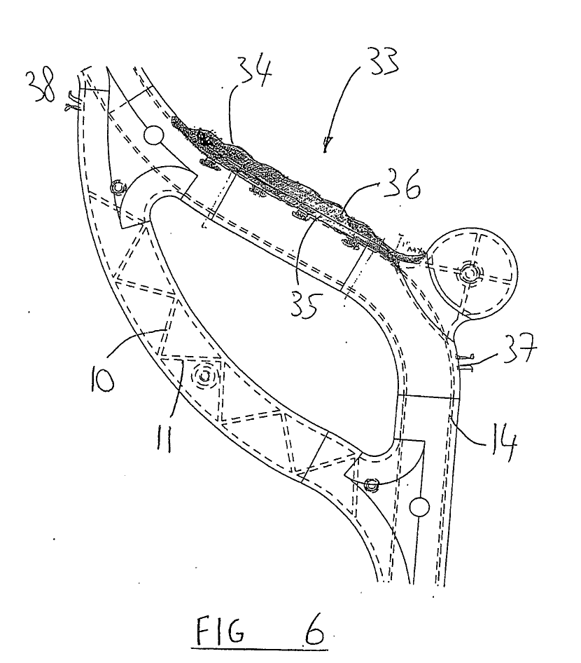

FIG. 13b shows a ring-shaped armpit engaging portion 81 which would allow a user to place their hand through the ring and grip the handle 80. As envisaged in previous embodiments, it is feasible for such a ring arrangement to have a break in order to allow the arm/shoulder of the user to escape from the fitment if stretched beyond its normal use. Reference in this respect is made to the discussion above relating to the cuff 30 as shown in FIG. 2, for example. The ring 81 may also incorporate a cushion or other shock absorbing means as appropriate to the person skilled in the art.

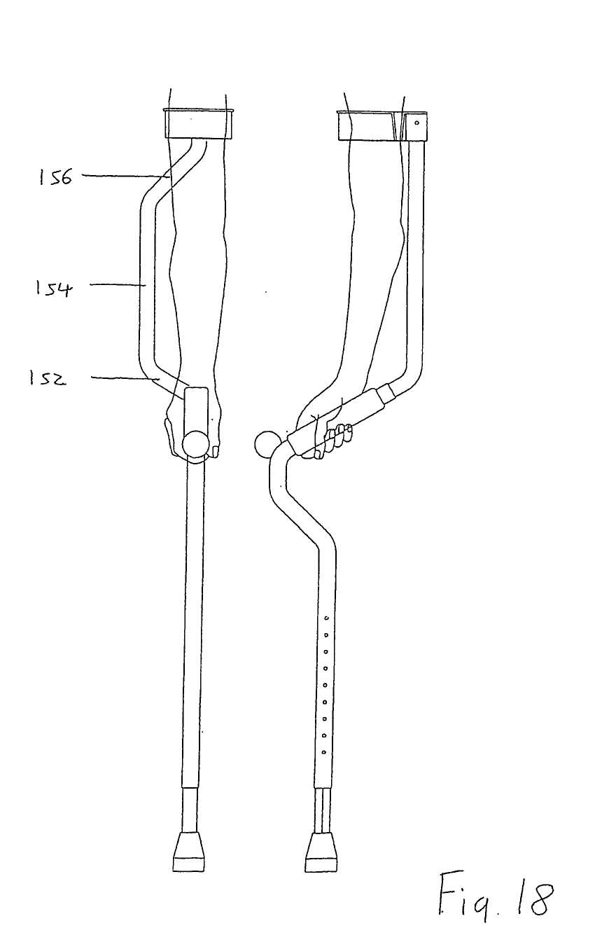

Referring to FIG. 14, there is shown a one-piece crutch of the below-elbow type. The crutch comprises a foot 120, an elongate leg 122 extending from the foot 120 in a straight line, a forward directed portion 124 extending in a forward and upward direction form the top of the elongate leg 122, an intermediate portion 126 extending from the top of the forward directed portion 124 in a direction substantially parallel to the elongate leg 122, a backward directed portion 128 extending from the top of the intermediate portion at an angle such that the backward directed portion crosses the straight line direction of the elongate leg at an angle which is the same as the natural angle between the user's hand grip and arm when in use, and an upper portion 130 extending from the top of the backward directed portion in a direction substantially parallel to the elongate leg and intermediate portions. The upper portion 130 comprises an upper arm support tube which is adjustable. The upper portion may be adjustable in length and/or angle. The elongate leg, forward directed portion, intermediate portion, backward directed portion and upper portion are all co-planar.

The forward directed portion, the intermediate portion and the backward directed portion form a curved handle with an open ‘U’ or ‘V’ type shape.

A cuff 132 is provided at an upper end of the upper portion of the crutch. The cuff acts as an arm support element in use and comprises a plastic ring structure with an opening therein. This opening is on a rear side of the forearm, in use allowing the front of the cuff to give allowing free-play as well as providing biodynamic bracing. The upper portion and cuff fix the orientation of the user's arm relative to the handle part in the optimum position to minimise joint stress for the user.

It is to be noted that the cuff 132 opens at the side and not in the centre front, as is the case with current designs. In one arrangement, the cuff opens on the inside of the cuff, that is facing the body of the user when in use. This may entail the provision of left-hand and right-hand ‘sided’ crutches supplied as a pair. The cuff opening is applied to both upper arm and lower arm cuffs.

The cuff may be hingedly mounted to the upper portion of the crutch to be adjustable to meet a user's needs. In use, the cuff grips around the forearm of a user to thereby support the arm of the user.

A hand grip 134 is mounted on the backward directed portion of the crutch. The hand grip can be a rubberised shock absorbent cover which is interchangeable or a personalised thermodynamic plastic moulding, which, when gripped by the user, will mould to fit the hand of the user exactly. The cover can be removable/disposable. A ball member 136 is provided at a lower end of the backward directed portion so as to prevent a user's hand from slipping off the hand grip when in use.

The above-described arrangement is such that the angled hand grip is positioned above the elongate leg whereby in use a user's arm is positioned in a substantially vertical direction in line with the elongate leg of the crutch with the user's hand gripping the hand grip at a natural angle to the user's arm. This natural angle will vary slightly for different users, but is generally greater than 90° up to about 140°, is more preferably from 100 to 130°, and is most preferably about 115°. Accordingly, forces are transmitted substantially vertically up through the user's arm and thus torsional forces on the user's joints are reduced, minimising anatomical damage. Furthermore, the angular arrangement of the different portions provides a curved handle which is flexible and absorbs shock during use. This reduces the shock imparted on a user's arm and thus minimises joint stress and anatomical damage. The one-piece crutch may come in a range of different sizes to fit the height of different users. Alternatively, the crutch may be provided in a standard length which may then be cut by a technician to fit the height of a user. For example, the crutch may be provided with a standard ‘grip to ground contact point’ length, and this may be trimmed by a technician to fit the height of a patient.

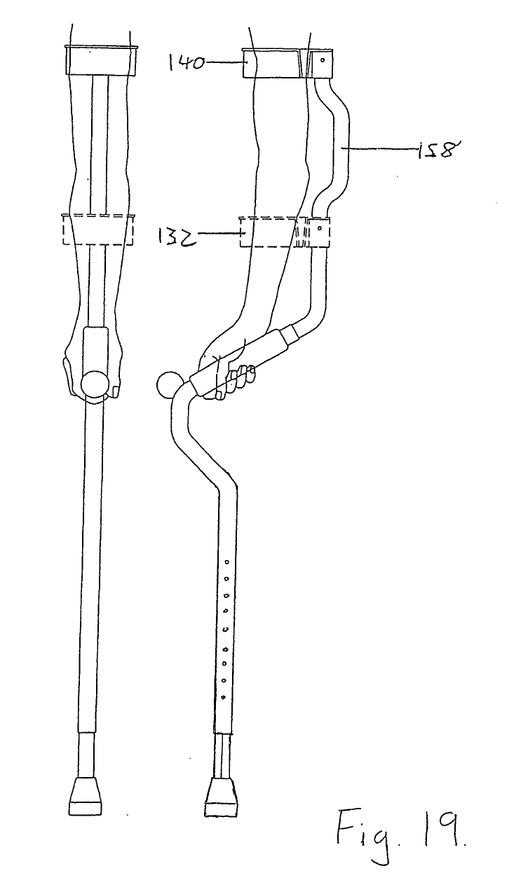

FIG. 15 shows a one-piece crutch of the above-elbow type. This arrangement is similar to that shown in FIG. 14, but with longer backward directed and upper portions. The upper portion has a forward directed portion 138 which extends towards a straight line extending from the leg, with a cuff connected thereto to provide an upper arm support element 140. In this arrangement, in use the cuff grips around an upper arm of a user. An opening is provided in the upper arm support. This opening is on the ‘arm pit’ side (medial) allowing the front of the upper arm support to give as well as providing biodynamic bracing. The extended length of the backward directed portion and the forward directed portion of the upper portion provide a curved upper portion having space for a user's elbow for enhanced manoeuvrability.

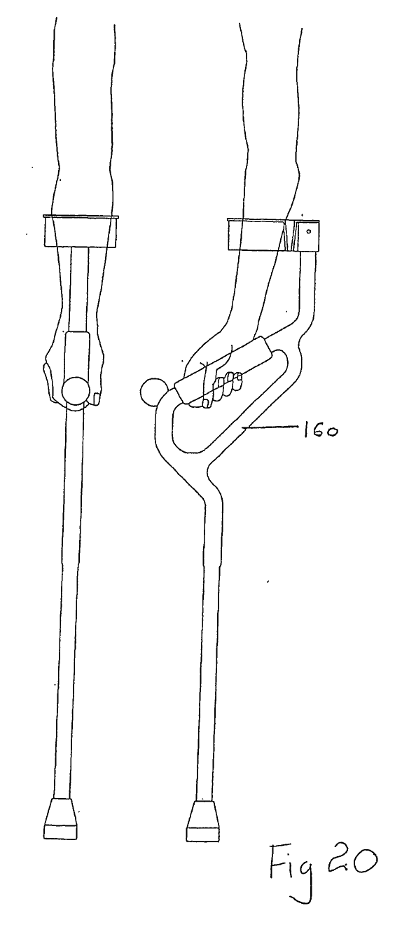

FIGS. 16 and 17 show embodiments of the present invention similar to those illustrated in FIGS. 14 and 15, but with the additional feature of a telescopic leg 142 for adjusting the height of the crutch. The telescopic leg comprises an outer element 144 with holes 146 therein and an inner element 148 which extends into the outer element 144 and has a retractable pin (not shown) for cooperation with the holes 146 in the outer element 144 to lock the two elements together. The inner element preferably has a line 150 extending along its length and indicates the circumferential position of the retractable pin. The line 150 may be aligned with the retaining holes in the outer element to aid in aligning the retractable pin with the holes to lock the two elements together. Accordingly, a ‘Steve’ line is provided which is a marked line down the crutch to indicate alignment of the holes for the sprung loaded stop for adjusting the height of the crutch parts.

The adjustable telescopic leg may be marked in length units (for example cm) so that once the height is found by allowing the grip height to match the wrist height of a user on one crutch, a numerical value is found for fitting of the other crutch if two crutches are required. The numerical value may also be recorded in the patient's notes for future reference.

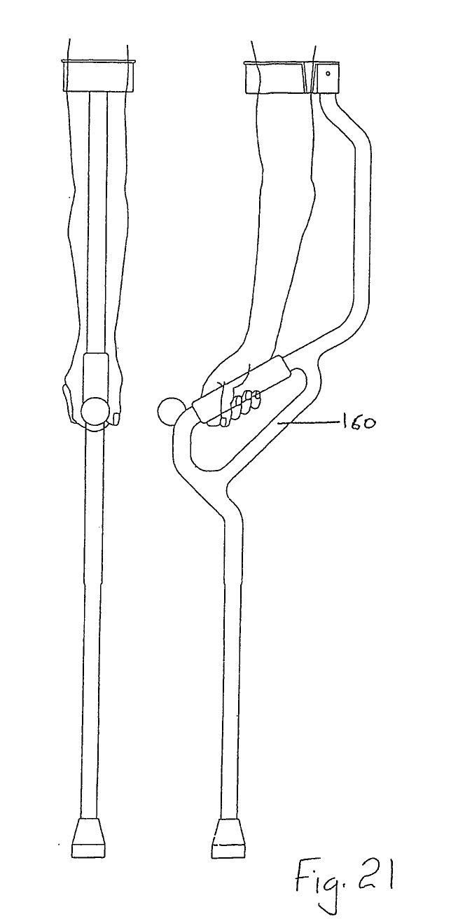

Upper sections of the crutch may be a simple one-piece structure as illustrated in FIGS. 16 and 17. In the embodiment shown in FIG. 18, a lateral curve is provided in the upper sections of each crutch. The upper section of these crutches comprises a first section 152 angled upward and outward from a user's body in use, a second section 154 substantially parallel to the elongate leg, and a third section 156 angled upward and inward towards the user's body in use. In this case, left and right handed crutches are mirror images of each other. The structure of the upper section provides more space for a user's arm to move in for added comfort and manoeuvrability.

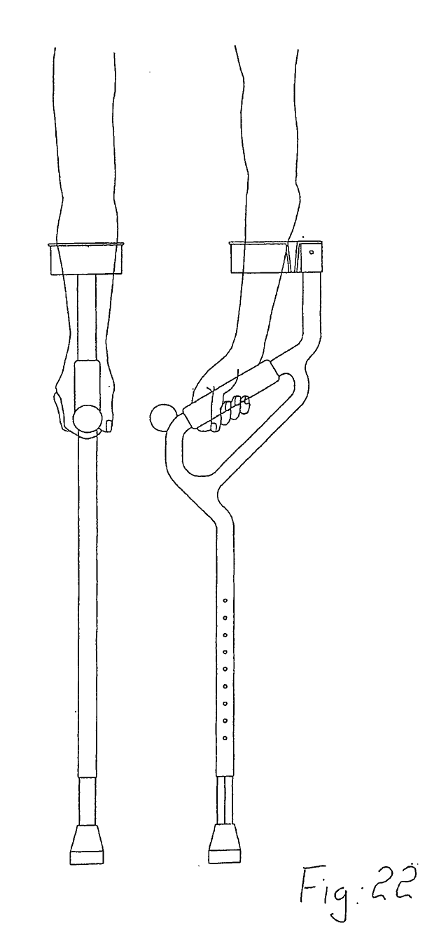

As an alternative to the simple one-piece construction, a multiple component crutch provided in kit form may be provided which is convertible between a below-elbow type crutch and an above-elbow type crutch. Such a crutch is shown in FIG. 19. The below-elbow type crutch illustrated in FIG. 16 is modified by attaching an above-elbow extension element 158 thereto. The lower arm support 132 may be removed on converting the below-elbow type crutch into the above-elbow type crutch. Alternatively, the lower arm support can be retained so that the above-elbow type crutch has both a lower arm support 132 and an upper arm support 140. The above-elbow extension element has curved portions so as to allow space to accommodate the arm and elbow of a user, as shown in FIG. 19.

The above-elbow section 158 can be made adjustable by an insert and locking frictional twist grip and/or be telescopic. The crutch may thus be a three section telescopic crutch. The above-elbow type crutch can be converted to a below-elbow type crutch quickly by removing the upper section 158.

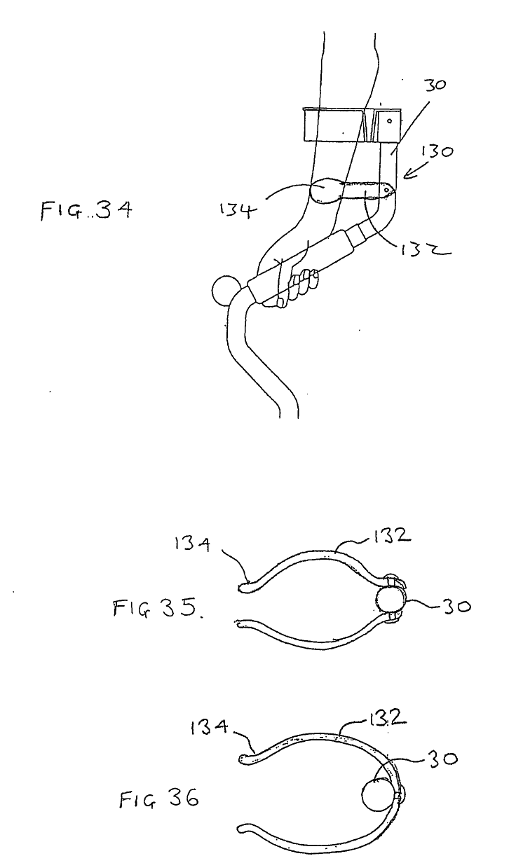

Both the above-elbow and below-elbow type crutches may have the benefit of above wrist offset wings. FIG. 34 shows a modified arrangement of the below-elbow type crutch of FIG. 16 with wrist offset wings 230 thereon. These are a pair of support arms which are located above the wrist joint and on each side of the wrist of the user in use to provide additional support at the front and rear, that is dorsal and ventral surfaces, of the wrist of persons with frail wrists. The support arms may be detachable and are typically about 8 to 10 cm long and about 1.5 to 3 cm wide. The support arms are attached to upper portion 130, typically 1 to 10 cm above the hand grip, but more preferably 2 to 6 cm and most preferably 3 to 4 cm. The support arms extend substantially horizontally in a forwards direction from the vertical upper portion on each side of the upper portion. The support arms comprise an elongate portion 232 and a contact portion 234, as shown in FIG. 34. Preferably, the contact portion provides a curved surface for contacting the wrist of a user for added comfort. The contact portion may be of a curved leaf-like shape. The elongate portion is preferably curved so that the support arm is spoon-shaped or paddle-shaped having a curved elongate portion and a paddle-like contact portion. The offset wings may comprise two separate support arms attached at either side of the upper portion. Such an arrangement is shown in FIG. 35, which shows a schematic cross-section view from above of the offset wings 230 attached to the upper portion 130. Alternatively, the offset wings may comprise a single curved portion attached to the upper portion with a pair of contact portions, one contact portion being located on either end of the curved portion as shown in FIG. 36. Ideally, the support arms are adjustably attachable up and down on the upper portion so as to be adjustable and attachable to fit a user. Furthermore, the support arms can be rotatably mounted to the upper portion 130 so that they can be rotated and fixed at various angles according to a user's needs.

FIGS. 20 and 21 show modified arrangements of the crutches shown in FIGS. 14 and 15 respectively. FIGS. 20 and 21 show one-piece crutches of the below-elbow type and above-elbow type respectively. The crutches may be trimmed to a height suitable for a user's needs. The structure has been modified from that illustrated in FIGS. 14 and 15 to incorporate a support bar 160 between the forward and backward directed portions. This rubber/spring compression support bar tube arrangement is such that when compressed on loading, the support bar aids in absorbing shock and provides some spring back. This arrangement provides a ‘lively’ spring/rubber assisted motion crutch which reduces shock transmitted from the ground contact point to the user. The support bar may be rigid or may be a rubber or sprung strut beneath the angled handle. While some known crutches are sprung at the foot, none are sprung in the region of the handle, where it is most effective in reducing the shock imparted to the user.

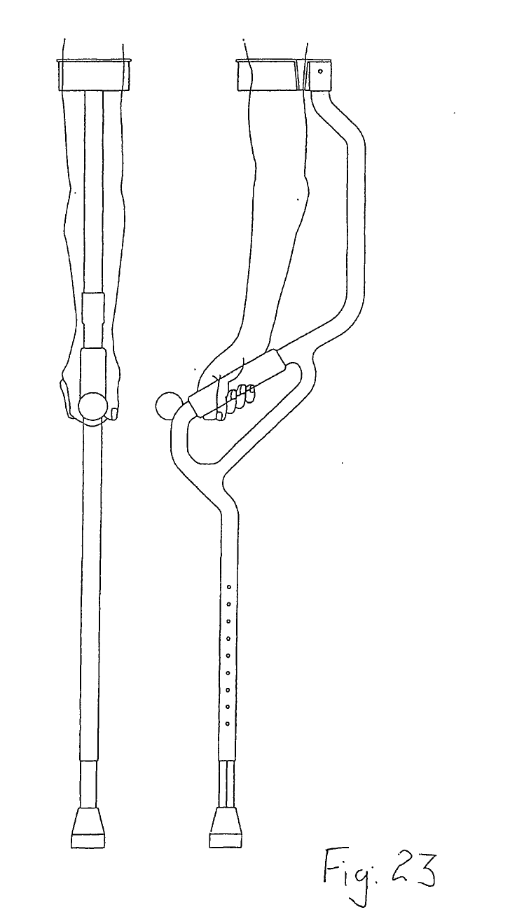

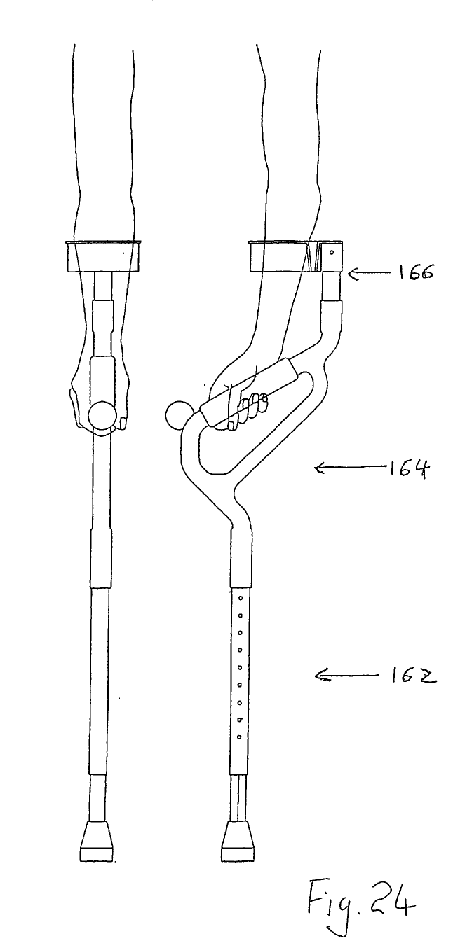

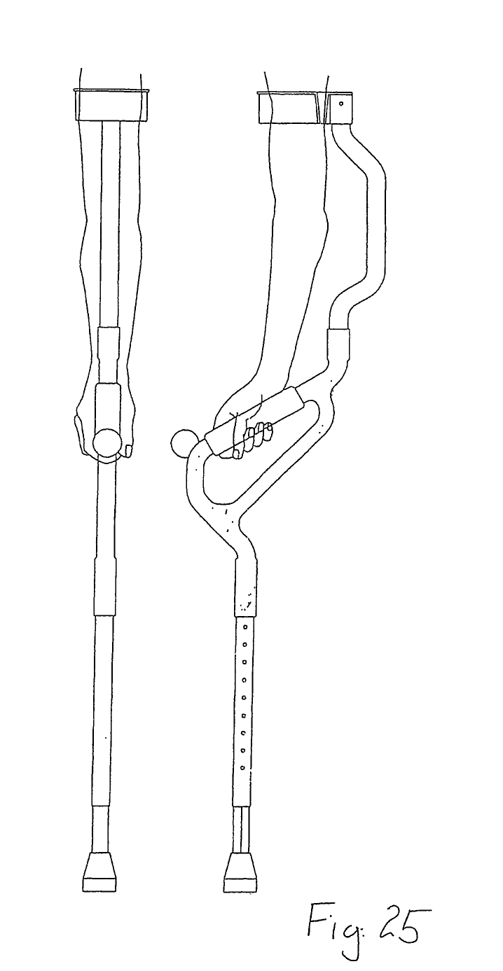

FIGS. 22 and 23 show schematic diagrams of arrangements similar to those shown in FIGS. 20 and 21, with the additional feature of a telescopic leg such that the crutch has an adjustable height.

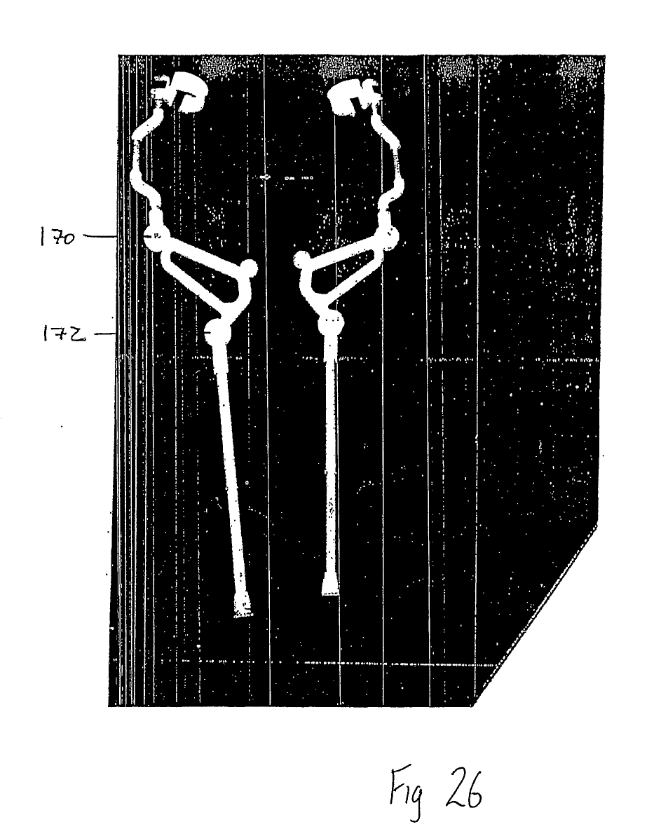

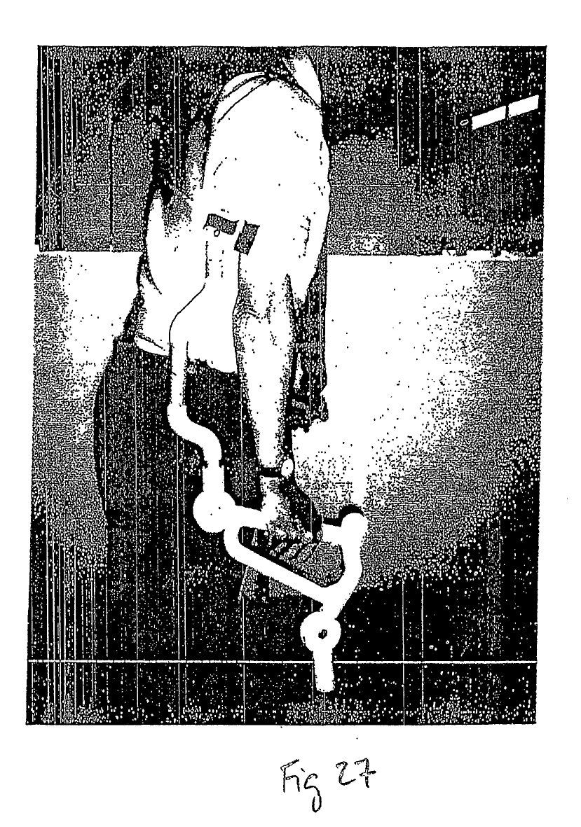

FIGS. 24 and 25 show another arrangement in which the crutch comprises multiple components and wherein the crutch can be converted between a below-elbow type and an above-elbow type. The crutch comprises a lower portion 162, a middle portion 164 and an upper portion 166. The lower portion comprises a moulded handle which is substantially similar to the handle illustrated in FIGS. 22 and 23. The upper portion comprises an arm support. FIG. 24 illustrates the below-elbow type configuration having a below-elbow arm support. The upper portion of the below-elbow type crutch can be removed and replaced with a longer portion comprising an above-elbow arm support so as to convert the below-elbow type into an above-elbow type crutch as shown in FIG. 25.

FIGS. 26 and 27 show views of a pair of crutches, each crutch being similar to that shown in FIG. 25. The hand grip is supplied with an above hand grip adjustable ratchet/hinge 170 and a below hand grip adjustable ratchet/hinge 172. Each crutch therefore has the ability to conform exactly to an individual patient's requirements. However, in other embodiments the adjustable sprocket parts are not present and the handle is made a different shape and size, that is smaller with a smaller offset from the foot pole to upper support part.

Furthermore, each crutch has both rigid and flexible portions so as to both support and reduce and absorb shock. The lower portion comprises an aluminium telescopic leg. The middle portion comprises a moulded handle/grip which is substantially similar to the hand grip illustrated in FIGS. 22 to 25. The upper portion comprises an arm support. This may be of the lower or upper type. The upper arm support type is shown in the photographs. The upper portion comprises straight aluminium portions with curved polymer material portions therebetween. The straight aluminium portions provide a strong support while the curved polymer portions provide a flexibility for absorbing shock.

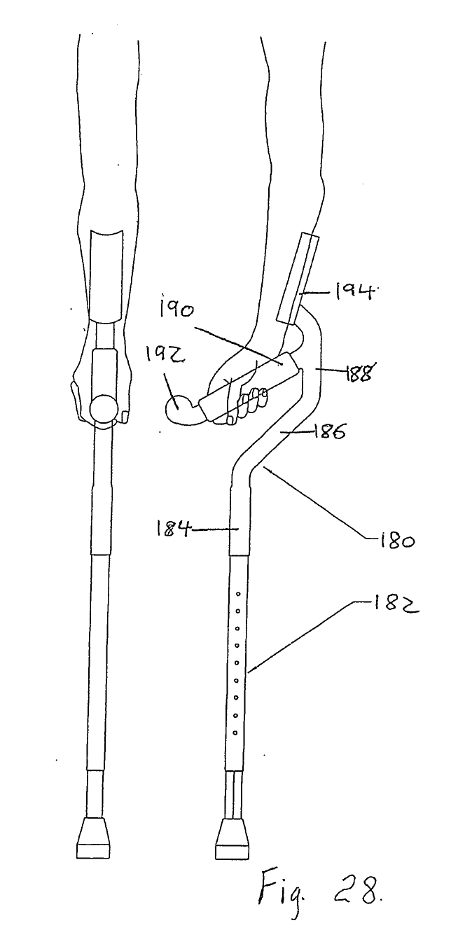

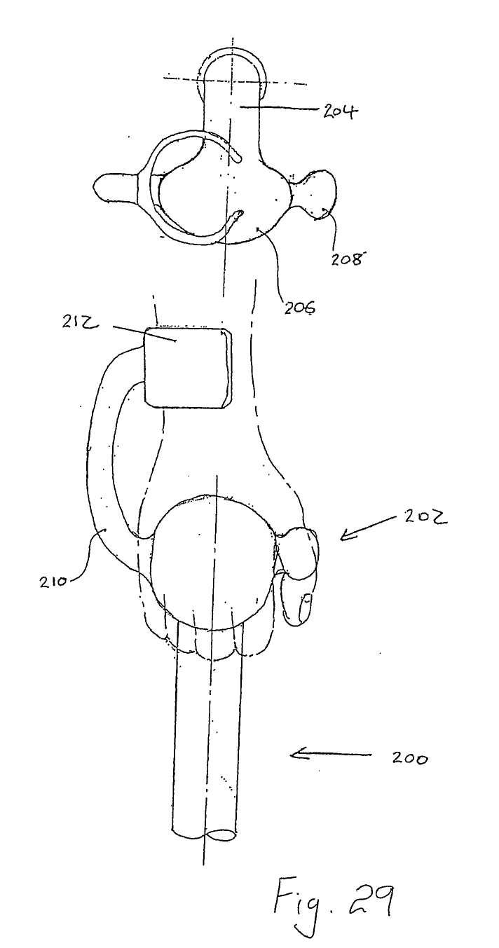

FIG. 28 shows another arrangement comprising a moulded handle 180 and a leg 182. The leg may be telescopically adjustable. Furthermore, the leg may be salvaged from and existing crutch. Such a ‘top loader’ anatomical hand grip which first over old type walking ends (sticks and crutches) is ‘eco’ friendly, cutting down wastage of old anatomical units. The moulded handle comprises a lower portion 184 which the leg fits into, a backward directed portion 186 extending from the first portion at an obtuse angle, and an upper portion 188 extending from the backward directed portion in a direction substantially parallel with the lower portion. A hand grip 190 extends from the upper portion, angled downwardly and forwardly and extending across the line of the direction of the lower portion. The hand grip 190 is located substantially straight above the lower portion. The hand grip terminates in a ball portion 192 to prevent a user's hands slipping off the hand grip during use. An elongate curved support member 194 is provided at a top end of the upper portion. The elongate curved support member 194 supports the lower arm of a user during use.

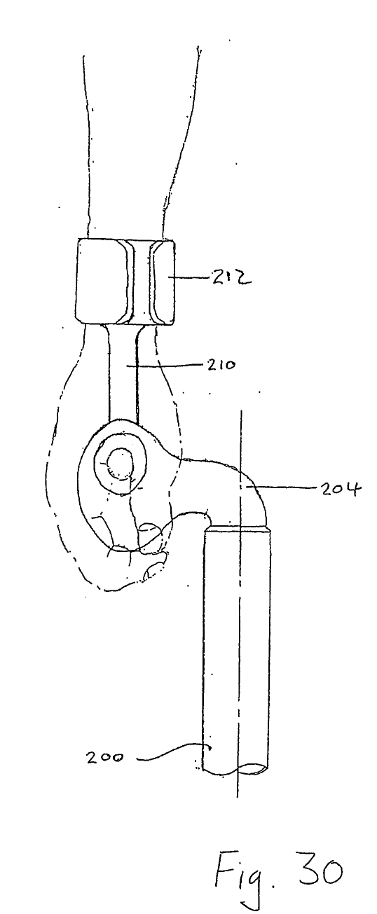

FIGS. 29 and 30 show front and side views respectively of another arrangement for a walking stick/crutch. This arrangement comprises a lower portion 200 (preferably an aluminium tube having an external diameter of approximately 25 mm) and an upper portion 202 attached to an upper end thereof. The upper portion 202 comprises the hand grip. The hand grip has a curved attachment portion 204 which extends from the leg of the walking stick/crutch and curves through an angle of approximately 90° to the ball shaped palm grip having a main palm pad 206 with a thumb grip 208 located on a side thereof. A wrist support strut 210 extends from an opposite side to that on which the thumb grip is located. The wrist support strut curves upwardly and ends in a wrist support member 212 for gripping and supporting a user's wrist in use. The ball grip is sized such that it fits the palm of a user's hand. In use, a user grips the ball with the knuckles facing forwards in the direction of travel. The arm is braced above the wrist/below the elbow. The wrist support strut may be mounted on the ball grip so as to be adjustable such that the angle of the wrist support strut can be varied according to a user's needs. This is beneficial to patients with anatomical variance and/or a preferred choice for comfort and ease of use.

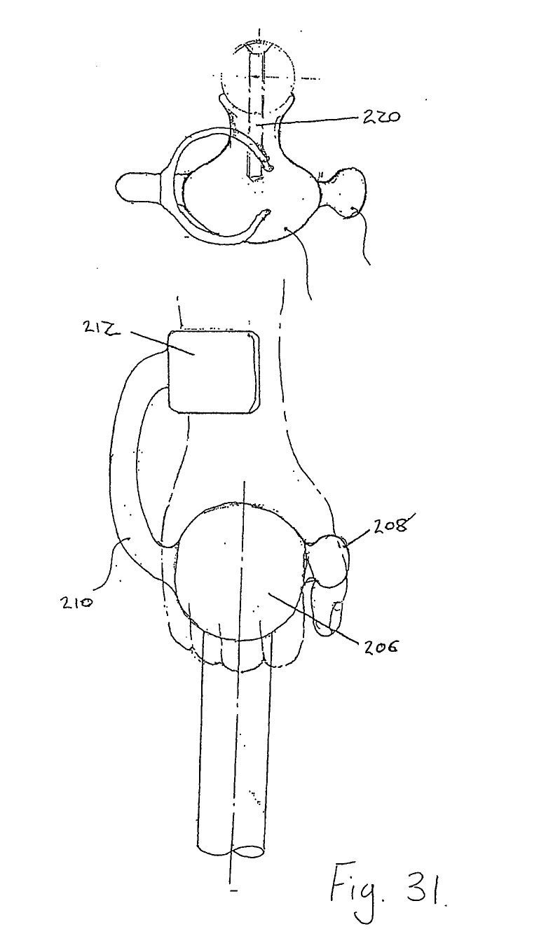

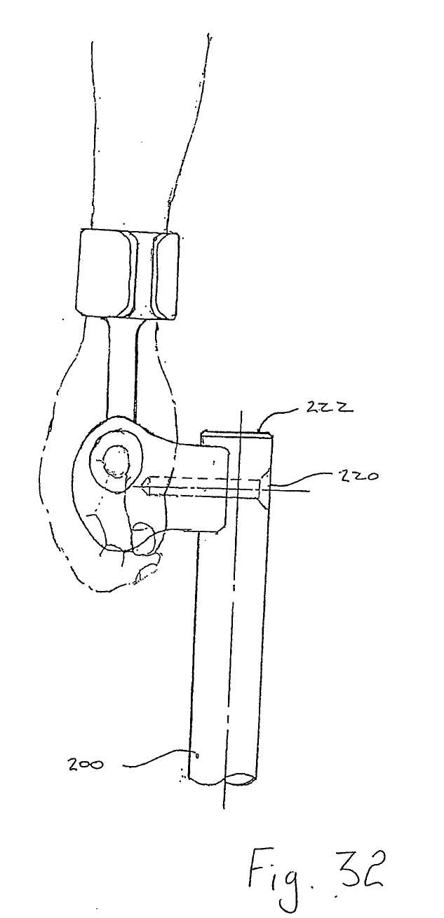

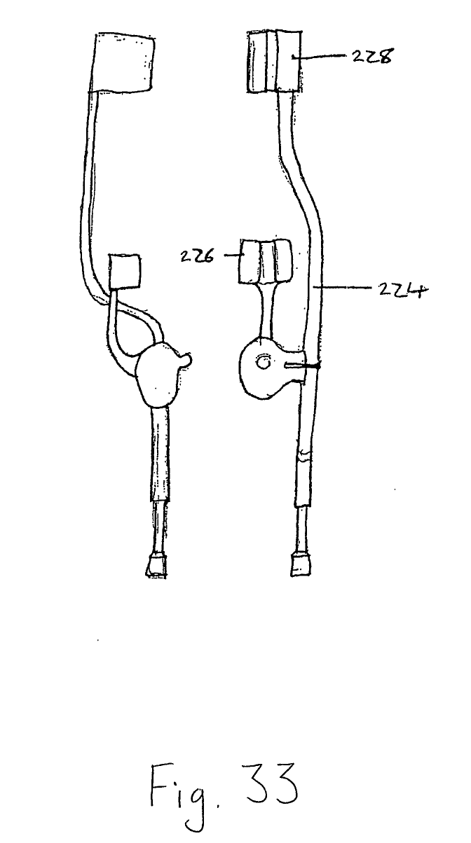

A modified arrangement of that shown in FIGS. 29 and 30 is shown in FIGS. 31, 32 and 33. In this arrangement, a palm grip is attached to the leg of the walking stick/crutch on a side thereof. In the illustrated arrangement, the palm grip is attached by a screw 220. This leaves a top of the leg portion free. A plastic cap 222 is provided on the top of the leg and an above-elbow portion 224 can be attached thereto so as to convert the below-elbow type crutch into an above-elbow type crutch having a lower arm support 226 and an upper arm support 228 as shown in FIG. 33. The palm grip type handle has the advantage that a user can grip the ball at a variable angle according to their needs.

Any of the above described hand grips can be converted to fit non-anatomical walking sticks and crutches. Furthermore, the hand grips may be applied to any device where grip, support or lift is required. According to embodiments of the present invention, crutches may be supplied subject to market forces as one-piece above- or below-elbow type units, cut to fit, in the most simple form, as disposable type single use units. Alternatively, crutches may be supplied as multi-functional ‘kit crutches’ using some or all of the aforementioned benefits driven by the medical/anatomical/personal market force. Embodiments of the present invention are therefore adaptable in their demand supply function.

Because the hand/wrist grip is in an advanced anatomical position requiring less pressure to be applied, better blood flow is obtained to the fingers, hand and wrist of the user as would be determined by pulse oximetry. Therefore, neurological damage is greatly reduced and median nerve damage is avoided and the consequential carpel tunnel syndrome that may occur from that, and elbow loading and strain is greatly reduced if not totally removed. Furthermore, less fatigue is felt on the hand, fingers, wrist and elbow. The crutch can be used for longer periods of time and thus patients obtain greater mobility and greater comfort and confidence. Stress levels are reduced and thereby healing is promoted. Accordingly, the present invention has numerous direct and indirect effects which improve on known devices.

A method of customising the angled handle for individual hands (left and right) uses a Soft Cast™ (3M Health Care) rapid setting resin bandage wound round the handle. The patient with a latex glove on is asked to hold the crutch handle lightly and comfortably for a few minutes until setting has taken place. A neoprene or rubber cloth covered saddle is applied to the set resin bandage to minimise chafing. This method can produce a handle matched to the patient's hand, is a new use for the bandage and can be constructed in a shape which allows for weight bearing to be predominantly on the heel of the patient's palm rather than on the upper palm and fingers.

A frictional twist-ring locking mechanism is also proposed for extending the length of the upper arm part of the crutch, rather than the spring and stud mechanism for the lower foot part.

1. A walking aid comprising a leg with a handle located part way up the leg; the leg having a region below the handle which in use may engage the ground as a user leans onto the walking aid; and a region above said handle for supporting the arm of the user; characterised by any one or more of the following features:
a) the handle is an inclined elongate handle located between the leg's upper and lower regions the leg's handle, upper and lower regions have a common supporting bar; an arm being located across and beneath the handle between said upper and lower regions; and the arm formed of two parts which are clamped together to be secured onto the leg at the handle region; and/or
b) the upper region is bowed; and/or
c) said region for supporting the arm incorporates a cuff with a lateral opening and means allowing the cuff to be selectively attached to the leg with the opening in a first radial direction for use with the right arm and with the opening in a second radial direction for use with the left arm; and/or
d) said walking aid incorporates a region above said handle for supporting the arm of the user which has a brace spaced from said handle sufficiently to be located over the lower forearm region above the wrist; and/or
e) in addition to the inherent shock absorption of the handle, a damping compound is provided and located at least in part within the handle to cushion the pressure exerted by a user's hand on the handle; and/or
f) a shock absorber is provided in close proximity to said handle as an integral part of the walking aid.

2. A walking aid according to claim 1, wherein at least one of the two parts is of plastics material with webbing reinforcements.

3. A walking aid according to any of the preceding claims, wherein the upper region of said leg have first and second bowed portions which are telescopic.

4. A walking aid according to any of the preceding claims, wherein the damping compound is located between the supporting bar and a relatively rigid handle cover.

5. A walking aid according to claim 4, wherein the damping compound is resilient, is formed in part over the handle and is ergonomically shaped.

6. A walking aid according to any of the preceding claims, wherein a shock absorber is arranged as part of an arm located across and beneath the handle between said upper and lower regions.

7. A walking aid according to any of the preceding claims, wherein a shock absorber is arranged in an upper region of the lower portion immediately beneath said handle.

8. A walking aid comprising an elongate leg and a handle at an upper end of the elongate leg, the handle including an elongate hand grip to be gripped by a user in use, wherein the elongate hand grip is inclined at an obtuse angle with the longitudinal direction of the elongate leg.

9. A walking aid according to claim 8, wherein the angle is greater than 90° and less than or equal to 140°, preferably from 100° to 130°, more preferably about 115°.

10. A walking aid according to either of claims 8 or 9, wherein the elongate hand grip crosses a straight a straight line extending in the longitudinal direction of the elongate leg whereby in use the hand grip is directly above the elongate leg.

11. A walking aid according to any of claims 8 to 10, wherein the handle further comprises a curved portion disposed between the elongate leg and the elongate hand grip.

12. A walking aid according to claim 11, wherein the curved portion comprises a forward directed portion and an intermediate portion which is parallel with the elongate leg.

13. A walking aid according to any of claims 8 to 12, wherein said leg is a telescopic leg comprising an elongate outer tubular element with a line of holes therein, and an elongate inner element which extends into the outer tubular element and is slidable relative to the outer element, the inner element having a retractable pin for cooperation with the holes in the outer portion to lock the inner element, said inner element having a line extending along the outer surface in a longitudinal direction, said line indicating alignment between the retractable pin and the line of holes to aid in adjusting and locking the telescopic leg in position.

14. A walking aid according to any of claims 8 to 13, further comprising a stop element at a lower end of the elongate hand grip to prevent a user's hand from slipping off the hand grip in use.

15. A walking aid according to claim 14, wherein the stop element is a ball shape.

16. A walking aid according to any of claims 8 to 15, further comprising an upper portion having an arm support element thereon for supporting a user's arm when a user grips the hand grip in use.

17. A walking aid according to claim 16, wherein the arm support element comprises a cuff.

18. A walking aid according to claim 17, wherein the cuff has an opening therein, whereby a front portion of the cuff is flexible in use.

19. A walking aid according to claim 16, wherein the arm support element comprises an elongate element having a curved surface for cooperation with the user's arm.

20. A walking aid according to claim 16, wherein said upper portion is of a length whereby the arm support element is a lower arm support element, the walking aid being a below-elbow type crutch.

21. A walking aid according to claim 16, wherein said upper portion is of a length whereby the arm support element is an upper arm support element, the walking aid being an above-elbow type crutch.

22. A walking aid according to claim 16, wherein the upper portion has a lateral curve therein.

23. A walking aid according to claim 16, wherein the walking aid is provided with a below-elbow type upper portion and an above-elbow type upper portion, said above-elbow type upper portion being incorporated into the walking aid to convert the walking aid from a below-elbow type to an above-elbow type.

24. A walking aid according to claim 23, wherein the above-elbow type upper portion fits into the below-elbow type upper portion to convert the walking aid from a below-elbow type to an above-elbow type.

25. A walking aid according to claim 23, wherein the below-elbow type upper portion is replaceable with the above-elbow type upper portion.

26. A walking aid according to any of claims 8 to 25, wherein the walking aid further comprises a support bar extending from an under side of the hand grip and adjoining a lower point on the walking aid to provide support for the hand grip and to absorb shock during use.

27. A walking aid comprising an elongated leg and a handle, at an upper end of the elongate leg, wherein the handle includes a palm grip for fitting into a palm of the user's hand to grip the handle in use, and a connecting element extending between a side of the palm grip and the elongated leg, there being a continuous curved gripping surface, remote form the said side of the palm grip, extending between an upper surface and a lower surface of the palm grip.

28. A walking aid according to claim 27, wherein the elongate leg is displaced laterally from the palm grip.

29. A walking aid according to claim 27 or 28, wherein the handle further comprises a wrist support strut having a wrist support element thereon, the wrist support strut extending such that in use the wrist support member cooperates with and supports a user's wrist.

30. A walking aid according to claim 29, wherein the wrist support strut extends from a side of the palm grip.

31. A walking aid according to claim 29 or 30, wherein the wrist support strut is rotatably attached whereby the wrist support strut can be moved to, and fixed in, a required position relative to the palm grip according to a user's needs.

32. A walking aid according to any of claims 27 to 31, wherein a thumb grip is provided on a side of the palm grip for cooperation with a user's thumb.

33. A walking aid according to any of claims 27 to 33, wherein an above-elbow extension is provided which is attachable to an upper end of the elongate leg and which has an upper arm support disposed on an upper portion thereof to support a user's arm in use.

34. A pair of walking aids as claimed in any previous claim, wherein the pair of walking aids form a mirror image pair.

35. A handle for use in a walking aid, said handle comprising an elongate lower portion for attachment to an elongate leg, and an elongate hand grip to be gripped by a user in use, wherein the elongate hand grip is inclined at an obtuse angle with a longitudinal direction of the lower portion.

36. A handle for use in a walking aid or a disability device, said handle including a ball grip for fitting into a palm of the user's hand to grip the handle in use, and an attachment element extending form a side of the palm grip for attachment to an elongate leg, there being a continuous curved gripping surface, remote from the said side of the palm grip, extending between an upper surface and a lower surface of the palm grip.

37. A handle for use in a disability device, said handle comprising a lower portion for attachment to said device, and an elongate hand grip to be gripped by a user in use, wherein the elongate hand grip is inclined at an obtuse angle with a longitudinal direction of the lower portion.
